(19) United States
(12) Patent Application Publication
(10) Pub. No.: US 2011/0072985 A1
(43) Pub. Date: Mar. 31, 2011

(54) CUTTING DEVICE FOR LETTUCE AND OTHER FOOD

(76) Inventor: DOUGLAS M. GAUS, BOISE, ID (US)

(21) Appl. No.: 12/690,598

(22) Filed: Jan. 20, 2010

Related U.S. Application Data
(60) Provisional application No. 61/277,483, filed on Sep. 25, 2009.

(51) Int. Cl. A47J 43/04; B26D 1/02

(52) U.S. Cl. 99/537; 83/858

(57) ABSTRACT

A food cutting device has a raised platform with both food preparation surfaces and an opening through the platform through which cuttings may be forced or dropped. Across the opening are stationary blades that preferably do not move during operation. Pivotally connected to the platform is at least one moving blade that is swung toward the opening to both cut the food and force the food to and past the stationary blades. The moving blade may be part of a pivotal jaw that is manually swung down on top of food placed on, or overhanging, the stationary blades and opening. The jaw provides leverage to the user swinging the jaw, and the combination of generally parallel stationary blades in the platform and the moving blade, perpendicular to the stationary blades, allows quick swings of the jaw in succession to cut or shred the food as desired. A container may be provided underneath the platform to catch the cuttings. By cutting the food into the opening, by means of the stationary and moving blades, or sliding cut food from the food preparation surfaces to the opening, the user need not grasp cut food to transfer it to a strainer or bowl. The food preparation surfaces may be integral top surfaces of the platform and/or may include a removable cutting board(s).

This application claims benefit of U.S. Provisional Application Ser. No. 61/277,483, filed Sep. 25, 2009, and entitled “Cutting Device for Lettuce with Integrated Cutting Board”, the entire disclosure of which is incorporated herein by this reference.

### BACKGROUND OF THE INVENTION

1. Field of the Invention

The invention relates generally to food processing, and, more particularly, to a device for easily and quickly cutting varying types of lettuce, either in head form or individual leaf form, or other vegetables or foods, into bite size pieces for human consumption. The device may be utilized in the home or for small commercial use.

2. Related Art

Commercially, there are lettuce cutters on the market that work like a vertical-movement press, by forcing a head of lettuce through a set of perpendicular (“cross-cut”) blades using mechanical advantage. The press style lettuce cutters will cut an entire head of lettuce into bite size pieces with one downward press motion, commonly using a handle to execute the downward press motion. But to do this, they are usually made of very strong materials, such as aluminum or steel, and have product design requiring a complex, multi-component system to provide extra mechanical advantage for cutting through an entire head of lettuce in one pass. Due to the cost of manufacture and the size of such commercial products, it is prohibitive to sell these lettuce cutters to consumers in the home market.

Other than hand-held knifes made specifically for cutting lettuce, there are no products on the market known to the inventor for home use that make the process of cutting lettuce either easier, faster, or with less mess. Most consumers rely on cutting heads of lettuce by hand on a cutting board using a metal kitchen knife. Others use their hands to remove leaves of lettuce individually and then break them apart by hand to bite-size pieces. Either way, the conventional processes for getting lettuce cut or broken into bite size pieces ready for consumption are time consuming, tedious and messy processes.

### SUMMARY OF INVENTION

The invention is a cutting device comprising at least one knife or other blade connected to a platform and pivotal toward said platform and/or an opening in said platform, wherein the cutting device is suitable for cutting lettuces, other leafy greens, and/or other vegetables, into bite-size pieces ready for washing/consumption. The preferred cutting device comprises at least one moving jaw that pivots toward, and at least partially past, stationary blades that span an aperture in a platform of the cutting device. The stationary blades preferably are generally parallel to each other to cut the lettuce/vegetable at multiple locations in one direction and the moving jaw preferably comprises at least one blade that is transverse to the stationary blades for making at least one cut in a direction perpendicular to said one direction. The lettuce/vegetable cut by the combination of stationary blades and moving jaw are expelled or fall through the aperture to a space below the platform, for example, to be caught in a strainer or bowl. The cutting device further comprises a prepping surface, such as a cutting platform/board preferably directly adjacent to the aperture, for the seamless processing/cutting of foods other than lettuce normally used in preparing salads, for example, tomatoes, cucumbers, onions, mushrooms, olives, peppers, zucchini and other vegetables, as well as meats such as chicken, turkey or ham.

The preferred cutting device allows users to easily and quickly cut entire heads of lettuce into bite size pieces, by performing a short series of cutting passes with the moving jaw through the set of stationary blades in/on the platform. The moving jaw is hinged on one end and is manually pivoted toward said stationary blades to contact and cut any lettuce/vegetable lying on the platform of the device between the jaw and the stationary blades. As the jaw moves toward the lettuce/vegetable, blade edges on the moving jaw perform longitudinal cuts through the lettuce/vegetable, and then undersurfaces of the jaw push the lettuce/vegetable against and past the stationary blades. Recesses or gaps are provided in the blade edges of the moving jaw, and preferably also in said undersurfaces, so that portions of the moving jaw move to locations between or past the stationary blades. This way, blade edges are provided on both the moving jaw (facing generally downward) and on/in the platform (facing generally upward). The pivoting action of the jaw captures the lettuce/vegetable between these oppositely-facing blades and cuts through the lettuce/vegetable from the top and the bottom as the blades approach and preferably pass each other or nest relative to each other. The action of the blade edges of the moving jaw (making lengthwise cuts in the lettuce) and the stationary blades (making width cuts in the lettuce) results in rectangular bite-sized lettuce cuttings. The bite-sized cuttings may be similar in size and quality to that of pre-cut and pre-packaged store-purchased salad greens, without the preservatives and cost typically associated with said pre-packaged greens.

The preferred moving jaw and stationary blades are adapted to cooperate, without binding or jamming, through repeated, quick pivoting actions of the moving jaw, in order to progressively cut through an entire head of lettuce or large/long vegetable(s), for example. These repeated, quick actions may be called jaw “swings” or “chops”, wherein a handle or other proximal end portion of the moving jaw is firmly forced downward by the user to cut a first end of the head/vegetable that overhangs the aperture, followed by lifting of the jaw and further sliding of the lettuce/vegetable sideways over the aperture and underneath the jaw, followed by another film pivoting action to cut another section of the head/vegetable, and so forth. These repeated actions may be done quickly, for example, in a matter of seconds, until the entire head/vegetable has been slid into the space over the aperture, between the jaw and the stationary blades, and cut into pieces that fall through spaces between the stationary blades and into the container.

By adjusting the extent to which the user advances the lettuce over the aperture after each swing of the jaw, the user may adjust the size of the lettuce cuttings. For example, the lettuce cuttings will typically have one cut dimension generally equal to the distance between the stationary blades, but the other cut dimension will be generally equal to the distance the user has advanced the lettuce over the aperture. Thus, for example, the device may be used to cut lettuce into nearly-square pieces, if the lettuce is advanced about half way or more over the aperture, or thin strips, if the lettuce is advance only a few centimeters (1-3) over the aperture.

The preferred cutting device allows the user to transfer lettuce/vegetable cuttings into a salad strainer, bowl, or other food container without having to manually pick up the cuttings and without having to slide or transfer the cuttings off of the device from the outer perimeter of the platform. The cutting device platform is elevated, for example on foldable legs, above the countertop or other surface upon which it rests, to provide space below the platform that receives the salad strainer, bowl, or other food container. The aperture, across which the stationary blades span, extends all the way through the platform, so that it is open at its top and bottom. This way, when the lettuce/vegetable is cut by the combination of the moving jaw and stationary blades, the cuttings are expelled through the aperture of the platform. The cuttings fall from said aperture into the container by the force of the moving jaw pushing the lettuce/vegetable past the stationary blades and also by the force of gravity. Also, when a user chooses to cut or otherwise prepare vegetables or other food on the prepping surface, that is, the cutting platform/board adjacent to the aperture in the platform, the user may easily slide the cuttings over to the aperture so that said cuttings fall through the aperture to said container underneath the cutting device platform. Thus, whether the cuttings result from the jaw and stationary blade interaction to be expelled directly down through the aperture, or whether the cuttings result from the user using a knife on the platform/board adjacent to the aperture and sliding them to fall through the aperture, the cuttings fall directly below the platform into the container, where they are neatly caught and contained, without the user having to pick up the cuttings. Thus, the cuttings can go from the cutting device to a container without ever crossing the outer perimeter of the platform.

Special adaptations are made in the preferred cutting device to make the cutting action efficient and effective. For example, the moving jaw blades edges are preferably curved, and also notched or serrated, and the inner side surfaces are slanted slightly from vertical. These features help to grip the lettuce/vegetable, cut through it longitudinally with a “rocking” action, and push the freshly-longitudinally-cut surface slightly away (inward) from the sides of the moving jaw. Also, each recess or gap in the blades and underside surfaces of the moving jaw are preferably curved on a radius centered at the pivot axis of the moving jaw. Likewise, each stationary blade is preferably slanted away from being perfectly vertical, or slightly curved from top edge to bottom edge on corresponding radii centered on said jaw axis. Thus, in either option, the stationary blades are not exactly vertical. This way, the interaction of the moving jaw with the stationary blades, as the jaw pivots, is smooth and the mating of the stationary blades and recesses may be likened to tabs and recesses sliding together along the circumference of circles. If the stationary blades and the moving jaw recesses were exactly vertical, they would likely bind on each other, unless the recesses were made so large as to give a lot of leeway for mating of the moving jaw with the stationary blades. Such large recesses could provide a sloppy cut and/or cause more wedging and lodging of lettuce/vegetable in between the jaw and stationary blades in ways that might bind-up the jaw.

These and other objects of the preferred embodiments, and invented methods for using the preferred embodiments, will be apparent from the following detailed description and the drawings.

### BRIEF DESCRIPTION OF THE DRAWINGS

FIG. 1 is a top front perspective view of one embodiment of the invented cutting device, in a ready-for-use state with the jaw pivoted up from the platform into the open position, which provides a space between the jaw and the platform for receiving a portion of lettuce/vegetable.

FIG. 2 is a top front perspective view of the cutting device of FIG. 1, with the jaw in the closed position, wherein the jaw has been pivoted down to the platform to mate with the stationary blades of the platform, and wherein this position represents the jaw position after a “swing” of the jaw to cut the lettuce/vegetable.

FIG. 3 is a top front perspective view of the embodiment of FIGS. 1 and 2 in a collapsed configuration, with the jaw in a lowered position and the legs folded for storage.

FIG. 4 is a top front perspective view of the embodiment of FIGS. 1-3, with the preferred jaw removed and lifted up from the platform of the device, for example, for cleaning or replacement.

FIGS. 5A-E are various views of the jaw of FIGS. 1-4, with FIG. 5A being a bottom front perspective view, FIG. 5B being a right side view, FIG. 5C being a top view, FIG. 5D being a bottom view, and FIG. 5E being a front end view.

FIGS. 6A and B are top perspective views of the cutting device of FIGS. 1-5, with the jaw swung rearwards and removed from the platform, wherein FIG. 6B is a detail view showing details of the preferred structure that forms the pivotal, and removable connection of the jaw to the platform.

FIG. 7 is a top front perspective view of the embodiment of FIGS. 1-6B, with a schematic lettuce head positioned on the device prior to the first swing of the jaw, and with a container in the space below the device for receiving the cut pieces of lettuce.

FIG. 8 is a top front perspective view of the embodiment of FIGS. 1-7, with a carrot being cut on the cutting board surface adjacent to the stationary blades.

FIG. 9 is a top front perspective view of an alternative embodiment of the invented device, which has a removable cutting board that is normally received in a recess in a top surface of the device but which may be lifted up for cleaning or separate use.

FIGS. 10A and B illustrate details of the mating of the preferred jaw with the preferred stationary blades. FIG. 10B is a detail, partial side view of the jaw, taken generally from the area circled in FIG. 10A, showing the relationship of jaw recesses and stationary blades when the jaw is in the fully-executed down position, wherein the horizontal dashed line represents the plane/level of the top of the platform (region 16).

### DETAILED DESCRIPTION OF THE PREFERRED EMBODIMENTS

Referring to the Figures, there are shown some, but not the only, embodiments of the invented cutting device. The preferred embodiments comprise a device with a moving jaw, stationary blades spanning an aperture/opening in a platform, and adjacent food prep areas on/in the platform, which elements cooperate for quick and neat cutting of lettuce and vegetables for home or small-commercial use. The preferred single jaw is manually pivoted on a horizontal axis from a raised position to a lowered position extending generally across the platform toward the user and mating with the stationary blades. The preferred jaw has a length that makes it a significant lever arm, allowing the user to manually supply enough force for quick and forceful cutting, with no mechanical force apparatus other than the pivoting jaw. The preferred jaw blades and/or stationary blades are thin and sharp enough to cut lettuce but may still be reasonably safe to the user. The preferred device is easy to use, and, because of adaptations in the jaw and platform and blades, is unlikely to jam or bind. The preferred device is easy to disassemble and clean.

The cutting device 10 comprises a main body 12 that comprises a platform 14, which is a generally-horizontal plate or frame structure that has at least one solid region 16 and a rectangular cut-out area, also called “open area” 18, which is one example of an aperture extending through the platform from the top surface to the bottom surface of the platform. The solid region 16 has a continuous or substantially-continuous upper surface serving as a resting place for lettuce/vegetables as they are slid sideways into the space above the open area 18, and/or serving as a cutting board for use with a hand-held knife. The open area 18 is preferably located centrally on the platform 14, with a solid region 16, 16′ on each side to accommodate left or right hand use, as the user will choose a preferred hand for holding and sliding the lettuce/vegetable toward the open area 18 and the other hand for operating the moving jaw 40. The preferred open area 18 is defined by a rectangular wall 50 that passes through the platform 14, so that the open area 18 is open at its top and bottom, allowing lettuce/vegetables to pass through the open area, falling through the spaces between the stationary blades 22 that span the open area 18.

The main body 12 preferably comprises two or more legs 15 that support the platform 14 so that the platform 14 is held generally horizontally in the air above a countertop or table. The multiple stationary blades 22 that span the open area 18 have cutting edges 24 pointing generally upward.

Moving jaw 40 is preferably removeably connected to the platform 14 by a hinge mechanism 42. Jaw 40 is pivotal, during use, an amount relative to the horizontal upper surface of the platform 14 of at least 45 degrees and more preferably an amount in the range of 80-100 degrees. Jaw 40 is preferably pivotal upward and rearward more than 100 degrees, from a plane generally parallel to the platform 14, to place the hinge mechanism 42 in a configuration that allows removal of the jaw 40 from its axle 44, as will be detailed later in this document.

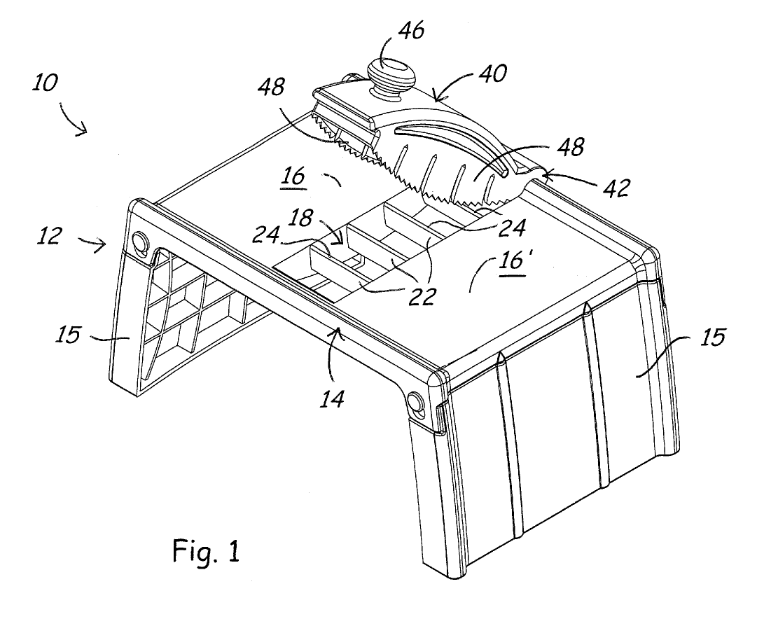

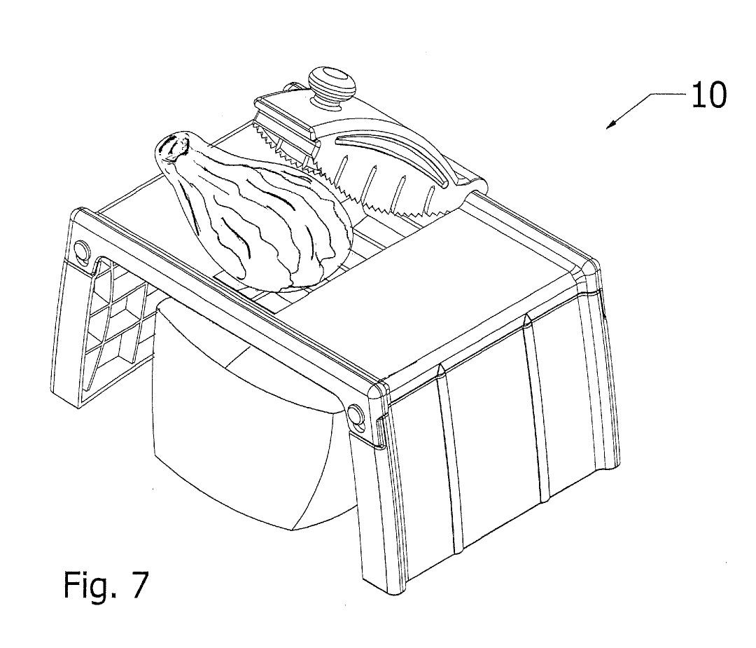

In the preferred use, the moving jaw 40 is swung open on its hinge 42 until it is in the range of 45-90 degrees relative to the platform 14 upper surface, for example, as shown in FIG. 1. The lettuce (or other similar leafy green) is placed on the platform 14, with a proximal portion resting on the solid portion 16 or 16′, and a distal end resting directly above the stationary blades 22 in the “cutting zone” space between the blades 22 and the jaw 40. See FIGS. 1 and 7, for example. Typically, the user grasps the proximal end of the lettuce with one hand, both to keep the lettuce in place on the device and to slide the lettuce horizontally after each swing of the jaw 40 to advance the lettuce, after each swing of the jaw, toward the cutting zone. To actuate the cutting action, the user uses his/her other hand to grab the handle 46 of the jaw 40 and pulls/forces the jaw 40 down across the lettuce head, until the jaw 40 passes entirely through the lettuce head and to/through the stationary blades 22, mating with the blades 22 in a closely-adjacent but non-binding relationship.

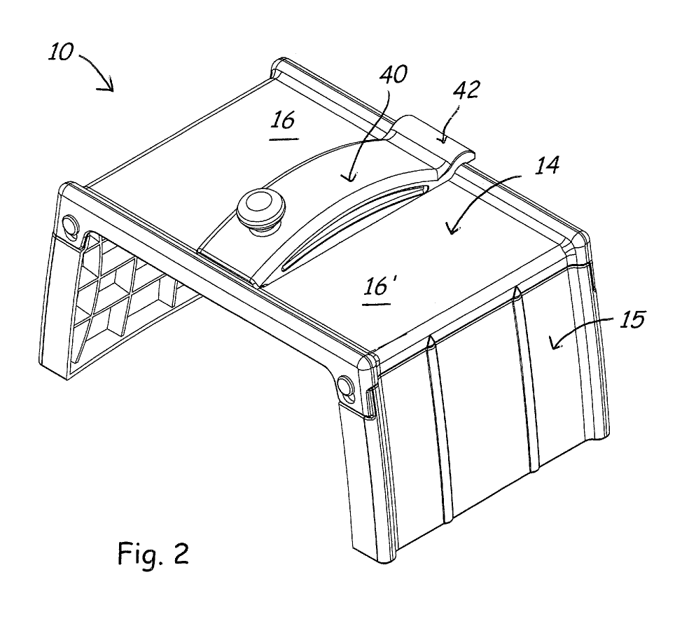

In the fully-executed down position, as shown in FIG. 2, the jaw 40 is “nested” or “mated” with the stationary blades 22, with enough clearance/gap between the surfaces of the jaw and stationary blades to prevent jamming. In this mated position, the side plates of the jaw 40, which preferably take the form of blades 48 with cutting edges 62, are inside the cut-out (open) area 18 of the platform 14, parallel to and immediately adjacent the side walls 50 of the open area, with the stationary blades 22 received in the recesses 52 of the jaw blades 48. This way, the jaw blade portions 54 extend down past the top edges 24 of the stationary blades 22 to protrude down on each side of each stationary blade 22. Also, preferably, in this fully-executed down position, the underside surface portions 53, separated by recesses 56, extend down between the stationary blades, with the stationary blades top edges 24 received in the recesses. The movement of the underside surface portions past the top edges 24 of the blades 22 further serves as a shearing means for producing cuts perpendicular to the longitudinal cuts of moving jaw blades 48.

Each underside surface portion 53 is preferably a generally flat, continuous surface, for pushing lettuce/vegetable past the edges 24 of the blades 22. In some embodiments, each underside surface portion 53 may be generally flat but will feature slight concavity and/or feature rounded side edges 55 near the jaw blades 48. Such slight concavity or rounded side edges will tend to urge the lettuce slightly inward toward the longitudinal centerplane of the jaw 40 and, thus, help prevent lettuce sticking/jamming in the area of the jaw blades 48 during the cutting process.

In the fully-executed down position, the jaw blade portions 54 have cut all the way through the lettuce/vegetable, the underside surface portions 53 have pushed the lettuce/vegetable all the way past the top edges 24 of the blades, so that the lettuce/vegetable is cut into rectangular pieces. The last few millimeters of movement of the jaw into this position continue to push the lettuce/vegetable through the spaces between the blades 22 so that they fall into the container.

The early portion of each swing of the jaw begins a vertically-downward “longitudinal” cut, which, if the head of lettuce is on its side with the length of the leaves transverse to the jaw length, results in a transverse strip being cut off from the end of the lettuce. The remainder of the swing of the jaw, as the lettuce is pushed down through the stationary blades 22, achieves cross-cuts of the newly-cut strip of lettuce, cutting vertically-upward through the lettuce in a direction parallel to the length of the lettuce leaves and perpendicular to the jaw length.

The preferred blades 22, 48 may be polymer/plastic, porcelain, metal, or other materials, and may be of various thickness and sharpness, depending upon the design goals. For example, the stationary blades 22 and the jaw blades 48 of the preferred embodiment may be optimized in thickness and sharpness for lettuce cutting, and so may be not as thin and sharp as, for example, a quality paring knife. In some embodiments, therefore, a person may slide his/her finger along the blades 22, 48 with a moderate amount of pressure without the skin being cut.

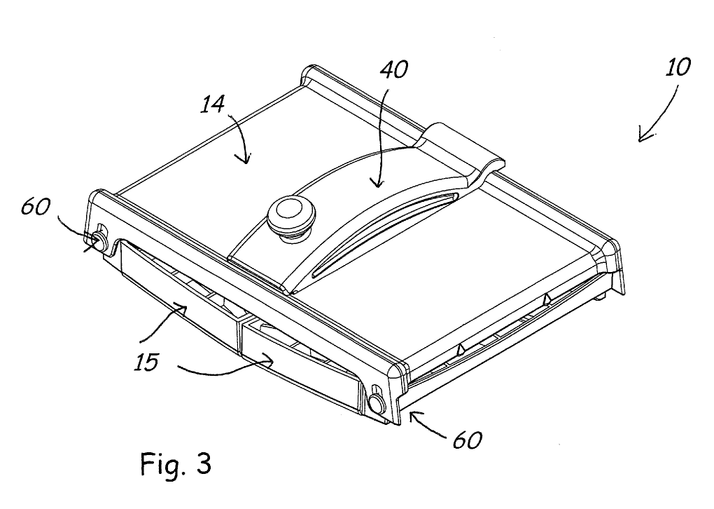

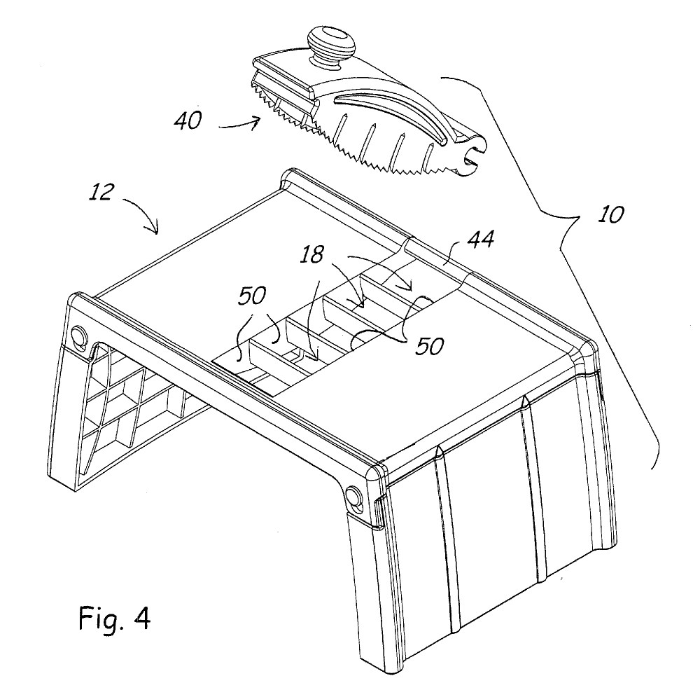

The preferred platform 14 and legs 15 are connected by means of a set of hinges 60. When the platform legs 15 are in the fully-open position on each side of the platform 14, as shown in FIGS. 1 and 2, the hinges 60 lock the legs to the platform so that it is in a sturdy state and will support any downward pressure on the platform 14 from the force of the jaw 40 upon the lettuce and platform 14 while cutting. The legs 15 may be unlocked and folded to place the cutting device 10 in a compact configuration, for example, as shown in FIG. 3. Various hinges and hinge locks may be used, as will be understood by one of ordinary skill in the art after viewing this disclosure and the drawings.

Alternatively, the legs may be of different numbers than shown in the Figures, for example, four or six legs. The legs may be connected and/or moveable relative to the platform by other means than shown in the Figures, such as telescoping length adjustment or other collapsible adjustment, threaded attachment, snap-on connections, jointed/fold-out length adjustment, and other means. The legs may be shapes other than those shown in the figures, for example, bent wire/rod that forms generally a U-shape. The legs may comprise non-skid surfaces or attachments for stabilizing the cutting device on a table or countertop. The legs may be hinged to the platform in a way that allows the legs to pivot outward so that the legs may lie generally in the same plane as the platform. Alternatively, but less preferably, the legs may be detachable rather than foldable. Also alternatively, but less preferably, the legs may be immovable relative to the platform, but this will result in a device that is less compact for storage. Also alternatively, but less preferably, the legs may take the form of a framework or structure below the platform that is, or comprises, a container for the cutting. For example, a container drawer may slide out from a leg structure that supports the platform above the table/countertop.

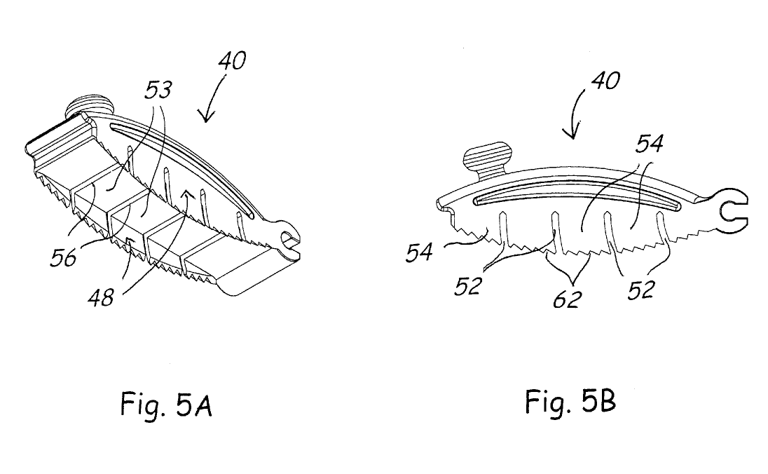

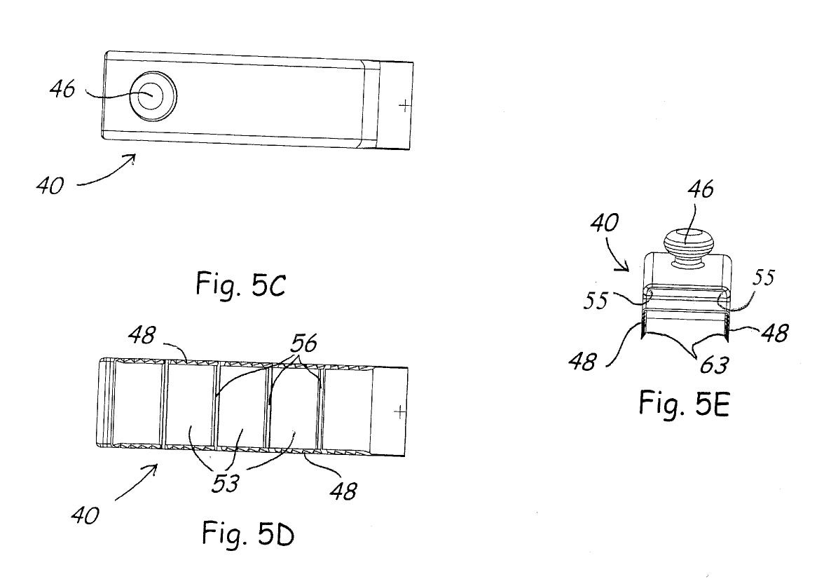

Details of the preferred jaw 40 are shown in FIGS. 5A-E. The jaw 40 has two blades 48, one on each of its outermost longitudinal sides. The two blades 48 can cut two parallel cuts through the lettuce simultaneously, with the distance between said two parallel cuts being approximately the width of the jaw 40. The lettuce/vegetable may be fed from one side of the jaw (from region 16, for example) in such a way that the lettuce does not overhang past the opposite side of the open area 18 (onto region 16′, for example), so that a single one of the blades 48 does all or substantially all of the longitudinal strip cutting. Even when a single one of the blades 48 is relied upon to do the longitudinal strip cutting, it is desired that the jaw 40 include two blades 48, to allow right of left hand use. Therefore, the preferred cutting device is symmetrical regarding the longitudinal (vertical) centerplane extending through the jaw midway between the two blades 48; each side may be a mirror image of the other.

Each blade 48 edge 62 is preferably convexly curved, so that the middle of the edge 62 protrudes farther out from the underside surface portions 53 than the front and rear portions of the edge 62. This way, the cutting of said two parallel cuts is accomplished by what may be likened to a “rocking’ motion of the blades 48, which results in a fraction of the total edge 62 first impacting the lettuce to begin the longitudinal cut, and then, as the jaw 40 continues along its path, more of the edge 62 cuts into and through the lettuce. Thus, the curved edge helps start an effective longitudinal cutting process. The edge 62 also is preferably serrated, which helps the edge grip and slice into the lettuce. By the time the jaw blades 48 reach the sidewalls 50 of the open space 18, the close proximity of the moving jaw blades 48 against/near the sidewalls 50 serves as a shearing means to finish the longitudinal cutting/sliding of the lettuce.

The inside surfaces 63 of each of the blades 48 may be slanted/tapered slightly, for example, as a method of achieving the desired blade thickness and sharpness, but also as a way to control the lettuce or other material being cut. Therefore, these surfaces 63 may extend inward from the edges 62 toward the underside surfaces 53, and, as described above in this document, the junction of the underside surfaces 53 with the blades 48 may be rounded or otherwise concave. The shape of surfaces 63 and underside surfaces 53 may, therefore, effect the sharpness, strength, and durability of edge 62, and help urge lettuce toward the longitudinal centerplane of the interior space of the jaw (between the blades 48) to help maintain cutting speed and quality. This adaptation helps make a clean and quick cut by keeping the lettuce from jamming between the jaw 40 and the platform 14 and by directing/pushing the cut lettuce slightly inward to better pass down through the spaces between the blades 22 when they are pushed by the underside surfaces 53.

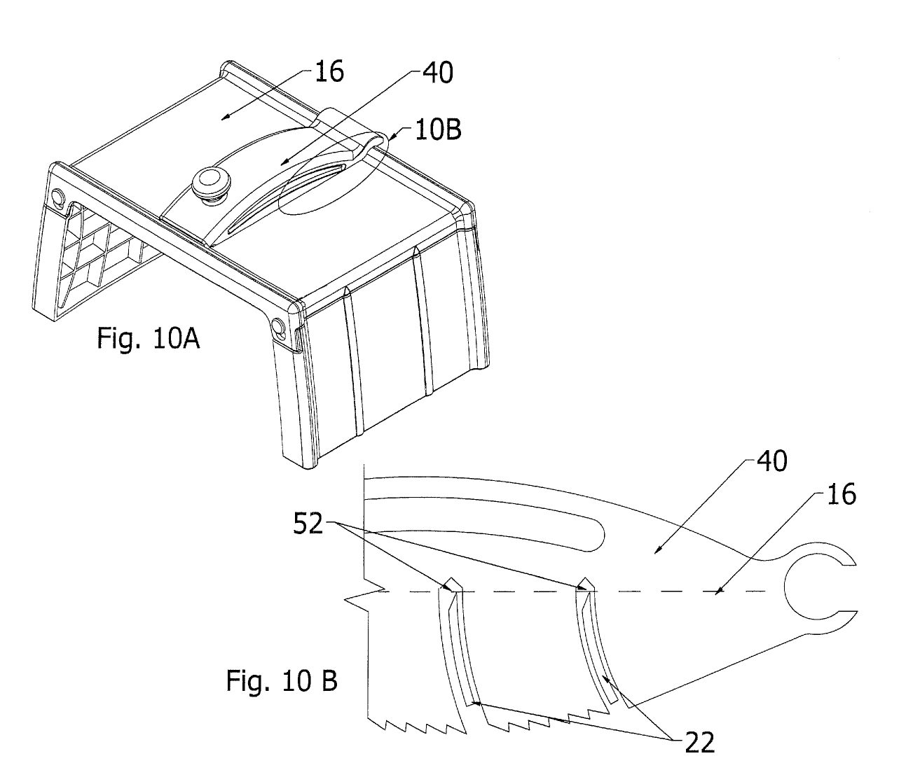

Other important adaptations of the preferred embodiment include the blades 22 and the cooperating recesses 52 of the jaw being slanted and/or curved to accommodate pivotal action of the jaw relative to the platform without binding. This is shown to best advantage in FIG. 10B. Each blade 22 and the respective recesses 52 of the jaw 40 (one recess 52 on each side of the jaw 40) are preferably curved on a radius, preferably corresponding to the distance from said blade 22 and respective recesses 52 to the pivot axis of the jaw. By curving each blade 22 and curving each recess 52, the “path” of each pivoting recess 52 matches the curvature of the respective blade 22, and the blade 22 and recesses 52 will mate properly as they are nested together. In other words, each blade 22 and its respective recesses 52 lie on the same (imagined) cylindrical surface so that pivoting (rotation) of one relative to the other is possible without binding/inference of the one with the other.

As there may be some clearance/space between the surfaces forming recesses 52 and the side surfaces of the blades 22, it may be more economical to curve all of the blades 22 on the same radius, rather than curving each blade 22 and each recess 52 to be slightly different (as would be the case, in theory, if each blade 22 and recess 52 were curved to match exactly the radius corresponding to the distance the sets of blade and recesses lie from the pivot axis of the jaw). For example, all the blades 22 and recesses 52 could be curved on an average radius representing the distance from the middle blade to the axle 44, or the distance from the middle of the open space 18 to the axle 44.

One will note in FIG. 10B that the preferred blades 22 are at or below (preferably only slightly below) the plane of the surrounding region 16 (or 16′), so that they do not protrude up from the platform. Because the axle 44 is preferably located at or near the level of the top surface of the platform (16 or 16′), the blades 22 are not contacted until the jaw 40 is nearly horizontal, and the jaw continues to move in mated relationship with the blades 22 some distance below the plane of the surrounding region 16 (or 16′). Therefore, the top edges 24 of the blades 22 are slightly forward (toward the user) relative to their lower edges, as can be seen in FIG. 10B. As a less-preferred alternative to curved blades 22, each blade 22 may be slanted but planar, and in embodiments wherein the blades are generally lower than the axle, the blades would be slanted forward (toward the user) at their top edges. However, this slanting without curvature would probably require that each blade be shorter from top to bottom and/or thin relative to the width of the recess 52, so that there would be more leeway in the fit/mating of the blade 22 and recess 52.

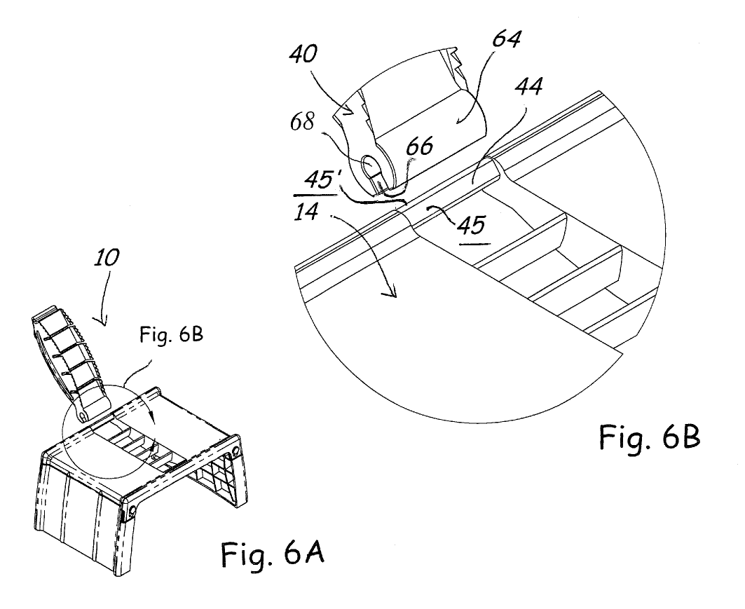

The jaw 40 is preferably detachable form the platform, for example, by a hinge mechanism 42 comprising an axle 44 around which an open sleeve 64 rotates. The axle 44 is non-cylindrical, that is, preferably flattened and reduced in diameter on two opposing sides 45, 45′, so that the opening 66 into the sleeve can slide over the axle 44 in one orientation, that is, the orientation shown in FIGS. 6A and 6B. Once the sleeve 64 is on the axle 44 and is rotated to another orientation, for example the orientations shown in FIGS. 1-3, the axle 44 is retained in the sleeve interior 68 and the jaw cannot be pulled off the axle. During normal operation, therefore, the jaw moves from about vertical to horizontal (against the platform), and in these orientations, the jaw sleeve 64 is captured on the axle 44. Only when the jaw is pivoted rearward past vertical, to approximately 130 degrees relative to the platform, is it removable from the axle 44. The hinge mechanism 42 is preferably the only connection of the jaw to the main body of the cutting device. Preferably, the cutting device includes no springs or other biasing or urging structure for the jaw, and the human hand is the only actuator and urging structure used to move the jaw.

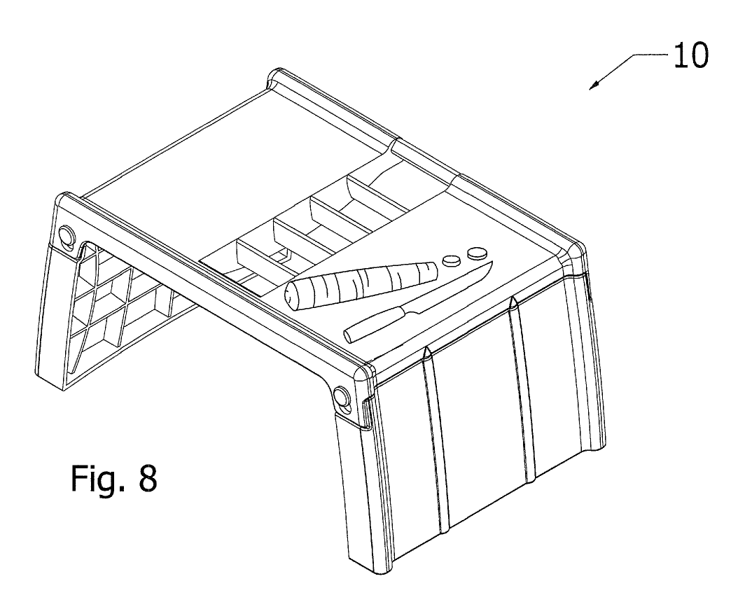

FIG. 8 illustrates how the platform may be used for more traditional cutting board use, wherein a user chops/cuts vegetables or other food on one or both of the solid regions 16, 16′. After cutting, the user may easily scrape the cut pieces toward and into the open area 18, so they fall to a container underneath the platform 14 (shown in FIG. 7).

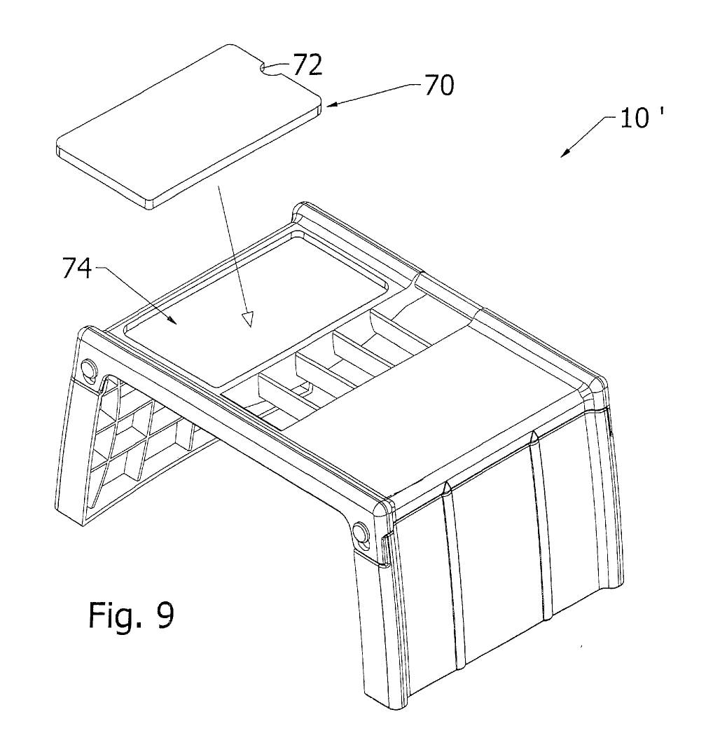

FIG. 9 illustrates an alternative embodiment of the cutting device 10′, which includes a removable cutting board 70. The cutting board 70 is positioned to one side of the open space 18 and is usable as a solid region (like 16, 16′) for supporting the lettuce/vegetable being cut by the jaw 40 and stationary blades 22, as discussed earlier in this disclosure and as generally portrayed in FIG. 7. Also, the cutting board 70 is usable for manual cutting/chopping with a knife, as discussed earlier in this disclosure and as generally portrayed in FIG. 8. Compared to these two uses, the main difference is that the cutting board 70 is removable for cleaning and/or for separate use on a table or countertop. Cutting board 70 may comprise a notch 72 or other handle that helps in removal of the cutting board 70 from its recess 74 in the platform. With the cutting board 70 lying in the recess, it is surrounded by a rim of the platform that prevents it from sideways movement during use. The cutting board shown in FIG. 9 covers/replaces almost the entire space to one side of the open space 18, but may be other sizes and/or shapes, preferably sizes and shapes that allow the cutting board to be reversible for use of both sides. Optionally, two removable cutting boards may be provided, one on each side of the open space 18, or a single cutting board may be provided that is moveable/reversible for use on either side of the open space 18.

It should be understood that alternative embodiments of the invention may be made with alternative shapes and designs for the main body of the cutting device, the open space or other aperture, jaw, and the stationary blades. Circular, oblong, or square platforms may be used, with various shapes and styles of optional removable cutting board(s). For example, an oval or circular platform may be used, with a half-circle or half-oval removable cutting board provided for placement in a recess or other rim/retainer on either side of the open area. The legs may be differently-shaped, with the goal being enough leg structure to lift the platform up from a container and retain it in a stable condition during repeated chopping of lettuce/vegetable with the jaw, and during use of one side or the other for manual knife-cutting of food. The cutting device may be made of various durable and cleanable materials, such as polymers/plastics and metals common in kitchenware, with the upper surfaces of the platform and/or optional removable cutting board 70 being made of various polymers/plastics, polypropylene, wood, or other materials used for conventional cutting boards. The container used to catch the cuttings is preferably a standard household receptacle separate from the cutting device. Alternatively, but less preferably, it may be a receptacle designed to key into the underside of the platform and/or otherwise be mated or connected with the cutting device.

Different numbers, lengths, and spacing of stationary blades and moving blades may be used, for example, to create different sizes and shapes of cuttings. The jaw preferably comprises two parallel blades, but may comprise fewer (one) or more than two. The stationary and moving blades may be permanently attached to the platform and jaw, respectively, or may be removable and replaceable. Whether the stationary blades are removable or not, they are unmoving relative to the platform at least during use of the device for cutting, and, hence, are called “stationary.” The preferred stationary blades are generally parallel, with no blades in or on the platform that are perpendicular (or otherwise significantly non-parallel) to the stationary blades. Thus, the preferred blades in or on the platform are not in a “cross-cut” arrangement, and therefore, by themselves, cannot cut lettuce/food off of the main lettuce head or vegetable body. While the preferred stationary blades may be slanted and/or curved, rather than perfectly planar, they may still be said to be “generally parallel” as they span the open space/aperture in the same direction, for example, from left to right across the open space/aperture. One or more moving blades, preferably in the form of a pivotal jaw, are supplied to complement the stationary blades to complete the cutting of the lettuce/food into rectangular-pattern or other-pattern pieces that can fall away from the lettuce head or vegetable body. Preferably, the blade(s) on the moving jaw 40 are the only blades perpendicular to the stationary blades 22. Preferably, the stationary blades are all contained within the open space 18 and no blades upend from the platform. The stationary blades may optionally have serrated top edges and/or may have other indentations or texture.

Preferably the axle 44 of the jaw is in a horizontal plane slightly above the stationary blades 22 or at the level of the top edges 24 of the blades 22, and all of the stationary blades are slanted with their top edges 24 being slightly farther from the axle 44 than are their lower edges. To create even a better fit of the blades 22 in the recesses 52, the blades 22 are preferably curved slightly to match, or substantially match, the circumference corresponding to rotation on the radius from the blade 22 to the axle 44, as discussed earlier in this document. By “substantially match” is meant that each blade 22 and its corresponding recess(es) 52 are preferably curved on a radius that is within +/−20 percent of the distance from the blade 22 and recess 52 from the axle 44.

Preferably, the jaw 40 is the only moving part during operation, with the legs being moveable only after operation when the legs are unlocked. Preferably, the jaw is the only hand-held portion of the cutting device during operation and the only removable part of the cutting device. Preferably, the jaw does not move vertically straight downward, but, rather, swings during use in an arc controlled by its being rigid and by its cooperation with axle 44. The pivot axle 44 of the jaw 40 may be modified to be other pivotal connections or hinges, as will be understood by those of skill in this field after viewing this disclosure and the drawings. For example, the jaw 40 may pivot/swing on an axis that is formed by two separate pivotal connections (one at each side of the jaw) rather than on a rod that extends all the way through the jaw.

Although this invention has been described above with reference to particular means, materials and embodiments, it is to be understood that the invention is not limited to these disclosed particulars, but extends instead to all equivalents within the scope of the following claims.

1. A food cutting device comprised of:
a generally horizontal platform having a cut-out area through the platform;
legs attached to the platform for supporting the platform above a table or countertop;
stationary cutting blades spanning across said cut-out area;
a moving jaw pivotally attached to the platform and moveable between a first position adjacent to said cut-out area in the platform and a second position relatively distant from the platform, the moving jaw having a longitudinal axis and two outward parallel plates that are parallel to said longitudinal axis and having cutting edges extending toward said platform, the cutting edges having recesses that receive said stationary cutting blades when the moving jaw is in the first position adjacent to the cut-out area in the platform.

2. The device of claim 1, wherein all of said stationary blades are generally parallel to each other and the device comprises no blades in the platform that are perpendicular to said stationary blades.

3. The device of claim 1, wherein the legs and platform are connected by hinges so that the legs pivot inwardly from an in-use configuration extending down from the platform to a storage configuration folded inward generally parallel to the platform, and the device further comprising a locking mechanism for locking the legs in said in-use configuration.

4. The device of claim 1, wherein the legs and platform are attached by hinges so that the legs pivot outwardly from an in-use configuration extending down from the platform to a storage configuration extending outward from, and generally on the same plane as the platform.

5. The device of claim 1, wherein the moving jaw comprises only two cutting blades, which are said two outward parallel plates having cutting edges extending toward said platform.

6. The device of claim 5, wherein said cutting edges are convexly curved.

7. The device of claim 1, wherein the moving jaw comprises an underside surface between said two plates that extends between, and is generally perpendicular to, said two plates, wherein said underside surface comprises recesses that receive top edges of said stationary cutting blades when the moving jaw is in the first position adjacent to the cut out area in the platform, wherein said underside surface extends substantially all the way between said stationary cutting blades for forcing lettuce or other vegetable down past the stationary cutting blades to cut said lettuce or other vegetable.

8. The device of claim 7, wherein said underside surface moves down past said top edges of the stationary cutting blades, when the moving jaw moves into said first position, to shear lettuce or vegetable placed over said cut-out area.

9. The device of claim 1, wherein said cut-out area of the platform is defined by a sidewall extending through the platform, and each of said two plates of the moving jaw are closely adjacent to said sidewall when the moving jaw is in the first position, so that the jaw moving along said sidewall into the first position shears lettuce or vegetable placed over said cut-out area.

10. The device of claim 1, wherein the moving jaw has a handle at one end of the jaw.

11. The device of claim 1, wherein each recess in the cutting edges of said two parallel plates of the moving jaw, and the respective stationary cutting blade received in said recess when the moving jaw is in the first position, are curved on an arc using a center axis of the moving jaw pivotal hinge as a center point.

12. The device of claim 1, wherein the platform has an upper surface on a platform plane and wherein the top edge of each of the stationary cutting blades faces upward and is at or below said platform plane.

13. The device of claim 12, wherein the moving jaw is pivotally connected to the platform at or near a rear edge of the platform, wherein each of the stationary cutting blades further has a bottom edge, a height between said top edge and said bottom edge, and a length transverse to said height, and wherein each of the stationary cutting blades is connected to the platform in an orientation selected from the group consisting of: slanted relative to vertical so that the top edge is forward relative to said bottom edge, and curved from top edge to bottom edge all along the length of each stationary cutting blade.

14. The device of claim 1, wherein the second position of the moving jaw is an angle of at least 90 degrees from that of the first position of the moving jaw.

15. The device of claim 1, wherein the moving jaw is removably attached to the platform.

16. The device of claim 1, wherein the platform has at least one inlay recess adapted to receive one or more separate pieces of cutting board material on top of the inlay recess.

17. A food cutting device comprising:
a platform having a top, a bottom, a front edge, a rear edge, and right and left edges, an aperture through the platform from the top to the bottom, and a generally horizontal upper platform surface adjacent to the aperture on at least two sides of the aperture;
a leg system extending down from the platform for supporting the platform above a horizontal surface so that the bottom of the platform is elevated above said horizontal surface;
a plurality of generally parallel stationary blades extending across the aperture;
an elongated pivoting jaw having a longitudinal centerplane and comprising a jaw blade parallel to said centerplane, the jaw being pivotally connected to the platform at or near the rear edge of the platform, so that the jaw is moveable between a lowered position near the platform wherein the jaw blade is perpendicular to the stationary blades and a raised position away from the platform upper platform surface;
wherein the jaw comprises underside surfaces that are generally parallel to said upper platform surface when the jaw is in the lowered position, the underside surfaces having underside recesses that extend across the jaw perpendicular to the jaw blade;
wherein the jaw blade has blade recesses; and
wherein the underside recesses and the blade recesses receive at least the top edges of the stationary blades when the jaw is in the lowered position, so that the jaw pivots toward the platform to cut food placed between the jaw and the platform by the jaw blade cutting through the food in one direction and by the underside surfaces forcing the food down past the stationary blades so that the stationary blades cut through the food in another direction perpendicular to said one direction; and
wherein the aperture is open at its top and bottom so the cut food falls past the stationary blades and down out of the aperture to a space below the platform.

18. A food cutting device as in claim 17, wherein the device comprises no blades in the platform that are perpendicular to said stationary blades.

19. A food cutting device as in claim 17, wherein the pivoting jaw is pivotally connected to the platform at or near the rear edge of the platform, wherein each of the stationary blades further has a bottom edge, a height between said top edge and said bottom edge, and a length transverse to said height, and wherein each of the stationary cutting blades is connected to the platform in an orientation selected from the group consisting of: slanted relative to vertical so that the top edge is forward relative to said bottom edge, and curved from top edge to bottom edge all along the length of each stationary cutting blade.

20. A food cutting device as in claim 17, further comprising a container in said space below the platform.

21. A food cutting device as in claim 17, wherein at least a portion of the horizontal upper platform surface adjacent to the aperture comprises at least one removable cutting board.

22. A food cutting device as in claim 17, wherein the jaw comprises two of said jaw blades that are parallel to each other on outer sides of the jaw.

23. A food cutting device as in claim 22, wherein said two jaw blades have cutting edges that are concave so that a middle portion of each of said cutting edges extends out farther from said underside surfaces than front and rear portions of said cutting edges.

24. A food cutting device as in claim 23, wherein the underside surfaces are concave.

25. A food cutting device as in claim 23, wherein the underside surfaces join to said two jaw blades at rounded corners.
